(19) United States
(12) Patent Application Publication
(10) Pub. No.: US 2022/0408690 A1
(43) Pub. Date: Dec. 29, 2022

(54) Water-Dispensing System for Use with a Dog Bowl

(71) Applicant: THOMAS MULLENAUX, SAN PEDRO, CA (US)

(72) Inventor: THOMAS MULLENAUX, SAN PEDRO, CA (US)

(73) Assignee: AQUAPHANT, INC, LAS VEGAS, NV (US)

(21) Appl. No.: 17/522,040

(22) Filed: Nov. 9, 2021

Related U.S. Application Data
(63) Continuation-in-part of application No. 17/361,635, filed on Jun. 29, 2021.

(51) Int. Cl. A01K 7/04; A01K 7/02

(52) U.S. Cl. CPC A01K 7/04; A01K 7/025

(57) ABSTRACT

The water-dispensing system with a dog bowl comprises a water generation system, a condensate pump, a condensate filter, a power circuit, a water storage reservoir, a housing, a release valve, and a watering device. The watering device further comprises a water pan and a housing pedestal. The housing contains the water generation system, the condensate pump, the condensate filter, the power circuit, the water storage reservoir, and the release valve. The water generation system, the condensate pump, the condensate filter, and the release valve are fluidically connected. The housing mounts on the watering device. The water generation system and the condensate pump electrically connect to the power circuit. The water generation system and the condensate pump receive electric energy from the power circuit.

### CROSS REFERENCES TO RELATED APPLICATIONS

This non-provisional application claims priority under 35 USC 120 to U.S. non-provisional application U.S. Ser. No. 17/361,635 filed on Jun. 29, 2021 by the inventor: Thomas Mullenaux. This non-provisional application claims U.S. non-provisional application Ser. No. 17/361,635 in its entirety.

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of watering equipment for animals, more specifically, an automated drinking bowl. (A01K7/02)

### SUMMARY OF INVENTION

The water-dispensing system with dog bowl comprises a water generation system, a condensate pump, a condensate filter, a power circuit, a water storage reservoir, a housing, a release valve, and a watering device. The watering device further comprises a water pan and a housing pedestal. The housing contains the water generation system, the condensate pump, the condensate filter, the power circuit, the water storage reservoir, and the release valve. The water generation system, the condensate pump, the condensate filter, and the release valve are fluidically connected. The housing mounts on the watering device. The water generation system and the condensate pump electrically connect to the power circuit. The water generation system and the condensate pump receive electric energy from the power circuit.

These together with additional objects, features and advantages of the water-dispensing system with dog bowl will be readily apparent to those of ordinary skill in the art upon reading the following detailed description of the presently preferred, but nonetheless illustrative, embodiments when taken in conjunction with the accompanying drawings.

In this respect, before explaining the current embodiments of the water-dispensing system with dog bowl in detail, it is to be understood that the water-dispensing system with dog bowl is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the water-dispensing system with dog bowl.

It is therefore important that the claims be regarded as including such equivalent construction insofar as they do not depart from the spirit and scope of the water-dispensing system with dog bowl. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a perspective view of an embodiment of the disclosure.

FIG. 2 is a top view of an embodiment of the disclosure.

FIG. 3 is a side view of an embodiment of the disclosure.

FIG. 4 is a schematic view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

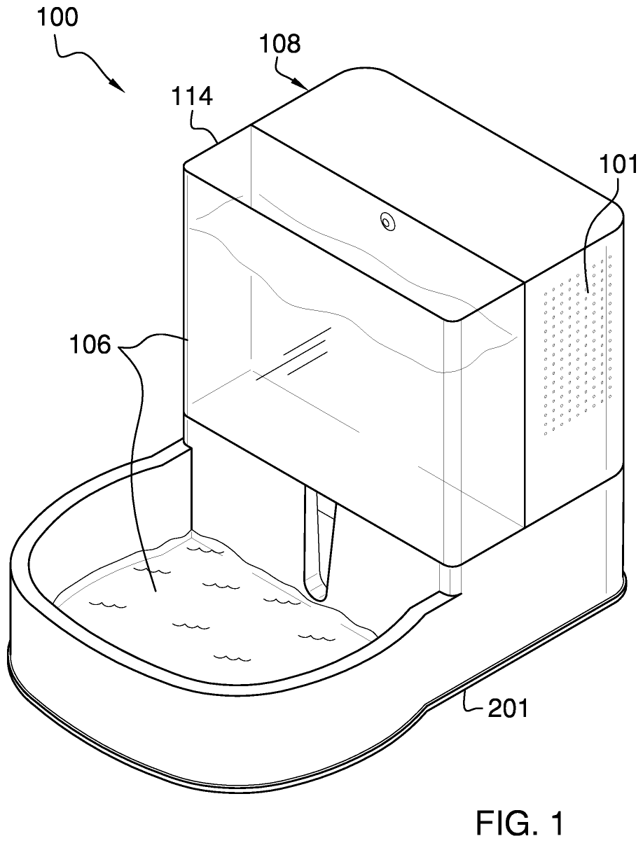

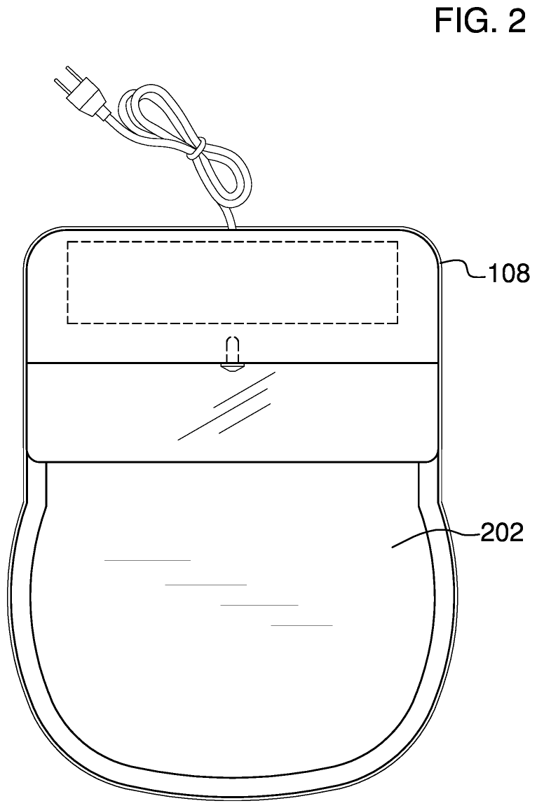

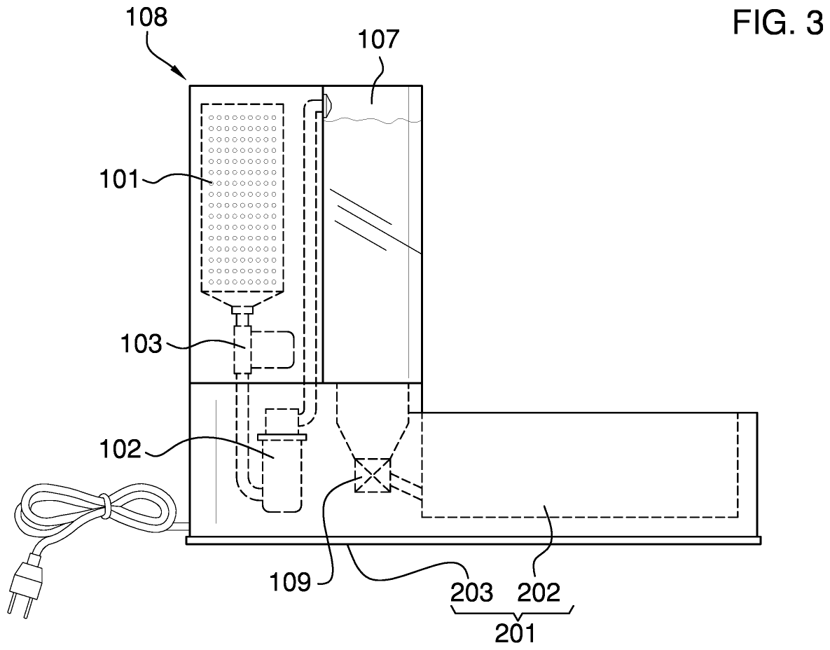

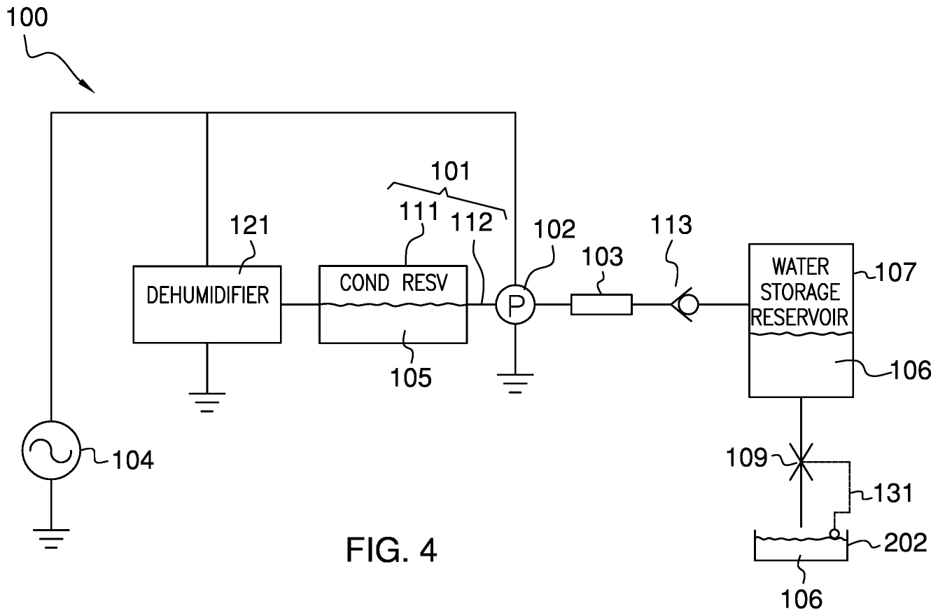

Detailed reference will now be made to one or more potential embodiments of the disclosure, which are illustrated in FIGS. 1 through 4.

The water-dispensing system with a dog bowl 100 (hereinafter invention) comprises a water generation system 101, a condensate pump 102, a condensate filter 103, a power circuit 104, a water storage reservoir 107, a housing 108, a release valve 109, and a watering device 201.

The water generation system 101, the condensate pump 102, the condensate filter 103, and the release valve 109 are fluidically connected. The water generation system 101 and the condensate pump 102 electrically connect to the power circuit 104. The water generation system 101 and the condensate pump 102 receive electric energy from the power circuit 104. The housing 108 mounts on the watering device 201. The housing 108 is a rigid structure. The housing 108 contains the water generation system 101, the condensate pump 102, the condensate filter 103, the power circuit 104, the water storage reservoir 107, and the release valve 109. The housing 108 is formed with all apertures and form factors necessary to allow the housing 108 to accommodate the use and operation of the invention 100.

The watering device 201 is a adapted for use with a companion animal. The watering device 201 provides drinking water 105 to the companion animal. The housing 108 attaches to the watering device 201 such that the watering device 201 provides a constant source of drinking water 105 for the water bowl 202. The watering device 201 further comprises a water pan 202 and a housing 108 pedestal 203. The housing 108 pedestal 203 attaches to the water pan 202 to form a lateral prism structure. The water pan 202 is a pan shaped structure. The water pan 202 receives drinking water 106 from the release valve 109. The housing 108 attaches to the housing 108 pedestal 203. Specifically, the housing 108 pedestal 203 forms a platform on which the housing 108 mounts.

The water generation system 101 is a mechanical system that condenses water vapor from the atmosphere into a liquid phase condensate water 105. The condensate water 105 is a source of water generated by the water generation system 101. The water generation system 101 further comprises a dehumidifier 121 and a condensate reservoir 111. The dehumidifier 121 and the condensate reservoir 111 are fluidically connected.

The dehumidifier 121 is a device that changes the phase of water vapor in the atmosphere into the liquid phase condensate water 105. The dehumidifier 121 is an electrically operated device that draws electrical energy from the power circuit 104. The use of a dehumidifier 121 is well-known and documented in the mechanical arts.

The condensate reservoir 111 is a containment structure. The condensate reservoir 111 collects condensate water 105 from the dehumidifier 121. The condensate reservoir 111 stores the condensate water 105 until the condensate pump 102 pumps the condensate water 105 through the condensate filter 103 and into the water storage reservoir 107.

The condensate reservoir 111 further comprises a condensate discharge port 112. The condensate discharge port 112 is a fluidic connection formed between the condensate reservoir 111 and the condensate pump 102. The condensate pump 102 draws the condensate water 105 out of the condensate reservoir 111 through the condensate discharge port 112 for transport into the fluid input of the condensate filter 103.

The condensate pump 102 is a mechanical device. The condensate pump 102 is an electrically powered device. The condensate pump 102 generates a pressure differential. The pressure differential generated by the condensate pump 102 transports the condensate water 105 from the condensate reservoir 111 and through the condensate filter 103 into the water storage reservoir 107. The condensate reservoir 111 controls the operation of the condensate pump 102 by controlling the operation of an electric motor that drives the condensate pump 102. The use of a pump is well-known and documented in the mechanical arts.

The condensate filter 103 is a filtering device. The condensate filter 103 filters the condensate water 105 as it passes through the condensate filter 103. The condensate filter 103 converts the condensate water 105 into the drinking water 106 by removing impurities contained within the condensate filter 103. In the first potential embodiment of the disclosure, the condensate filter 103 is a bed filter that passes the condensate water 105 through a bed formed of activated carbon.

The condensate filter 103 further comprises a condensate check valve 113. The condensate check valve 113 forms a direct fluidic connection between the discharge port of the condensate filter 103 and the water storage reservoir 107. The condensate check valve 113 transports the drinking water 106 from the condensate filter 103 into the water storage reservoir 107. The condensate check valve 113 limits the direction of the flow of the drinking water 106 to the direction from the condensate filter 103 into the water storage reservoir 107.

The power circuit 104 is an electric circuit. The power circuit 104 provides the electric energy necessary to operate both the water generation system 101 and the condensate pump 102. In the first potential embodiment of the disclosure, the power circuit 104 is the national electric grid.

The water storage reservoir 107 is a container that stores the drinking water 106 for the water bowl 202. The water storage reservoir 107 forms a fluidic connection with the condensate filter 103. The water storage reservoir 107 receives drinking water 106 from the condensate filter 103.

The release valve 109 is a valve. The release valve 109 releases the drinking water 105 from the water storage reservoir 107 into the water bowl 202. The release valve 109 is controlled by a float mechanism 131. The float mechanism 131 is a mechanical device. The float mechanism 131 automatically opens and closes the release valve 109 based on the amount of drinking water 105 that is in the water bowl 202.

The following definitions were used in this disclosure:

Align: As used in this disclosure, align refers to an arrangement of objects that are: 1) arranged in a straight plane or line; 2) arranged to give a directional sense of a plurality of parallel planes or lines; or, 3) a first line or curve is congruent to and overlaid on a second line or curve.

Ball: As used in this disclosure, a ball refers to an object with a spherical or nearly spherical shape.

Ball Check Valve: As used in this disclosure, a ball check valve is a type of check valve. A ball check valve is a valve that has a ball inserted into it such that the ball move freely within the valve structure. The flow of fluid applies a force to the ball check valve that provides the motive forces that move the ball within the valve structure. The ball check valve is structured such that the flow of a fluid through the ball check valve in a first direction presses the ball into the flow path of the fluid through the ball check valve such that the fluid will apply a pressure against the ball that closes the fluid flow path through the ball check valve in the first direction. The ball check valve is further structured such that the flow of a fluid through the ball check valve in a second direction pushes the ball out of the flow path of the ball check valve such that the ball check valve allows the flow of fluid in the second direction. The second direction is the opposite direction to the first direction.

Cant: As used in this disclosure, a cant is an angular deviation from one or more reference lines (or planes) such as a vertical line (or plane) or a horizontal line (or plane).

Center: As used in this disclosure, a center is a point that is: 1) the point within a circle that is equidistant from all the points of the circumference; 2) the point within a regular polygon that is equidistant from all the vertices of the regular polygon; 3) the point on a line that is equidistant from the ends of the line; 4) the point, pivot, or axis around which something revolves; or, 5) the centroid or first moment of an area or structure. In cases where the appropriate definition or definitions are not obvious, the fifth option should be used in interpreting the specification.

Center Axis: As used in this disclosure, the center axis is the axis of a cylinder or a prism. The center axis of a prism is the line that joins the center point of the first congruent face of the prism to the center point of the second corresponding congruent face of the prism. The center axis of a pyramid refers to a line formed through the apex of the pyramid that is perpendicular to the base of the pyramid. When the center axes of two cylinder, prism or pyramidal structures share the same line they are said to be aligned. When the center axes of two cylinder, prism or pyramidal structures do not share the same line they are said to be offset.

Check Valve: As used in this disclosure, a check valve is a valve that permits the flow of fluid in a single direction. Within selected potential embodiments of this disclosure, the check valve is a commercially available product that is selected from the group consisting of a ball check valve, a Tesla valve, and a duck valve.

Companion Animal: As used in this disclosure, a companion animal is a domesticated animal that is maintained primarily for companionship. A companion animal is often referred to as a pet.

Composite Prism: As used in this disclosure, a composite prism refers to a structure that is formed from a plurality of structures selected from the group consisting of a prism structure and a pyramid structure. The plurality of selected structures may or may not be truncated. The plurality of prism structures are joined together such that the center axes of each of the plurality of structures are aligned. The congruent ends of any two structures selected from the group consisting of a prism structure and a pyramid structure need not be geometrically similar.

Congruent: As used in this disclosure, congruent is a term that compares a first object to a second object. Specifically, two objects are said to be congruent when: 1) they are geometrically similar; and, 2) the first object can superimpose over the second object such that the first object aligns, within manufacturing tolerances, with the second object.

Correspond: As used in this disclosure, the term correspond is used as a comparison between two or more objects wherein one or more properties shared by the two or more objects match, agree, or align within acceptable manufacturing tolerances.

Disk: As used in this disclosure, a disk is a prism-shaped object that is flat in appearance. The disk is formed from two congruent ends that are attached by a lateral face. The sum of the surface areas of two congruent ends of the prism-shaped object that forms the disk is greater than the surface area of the lateral face of the prism-shaped object that forms the disk. In this disclosure, the congruent ends of the prism-shaped structure that forms the disk are referred to as the faces of the disk.

Drinking Water: As used in this disclosure, drinking water is water that is deemed safe for drinking or use in cooking by humans. A synonym is potable water.

Duck Valve: As used in this disclosure, a duck valve is a check valve. The duck valve is formed from two or more elastomeric structures. When the two or more elastomeric structures are in their relaxed shape, the duck valve forms a seal. The seal is oriented such that a fluidic pressure differential in a first direction will separate the two or more elastomeric structures allowing the fluid to flow through the duck valve in the first directions. When the fluidic pressure differential is in a second direction that is opposite to the first direction, the fluidic pressure applies a pressure that maintains the two or more elastomeric structures in their relaxed shape and prevents the flow of fluid through the duck valve in the second direction. A duck valve derives its name from a commonly used shape of the two or more elastomeric structures. A duck valve is also called a silicone valve.

Exterior: As used in this disclosure, the exterior is used as a relational term that implies that an object is not contained within the boundary of a structure or a space.

External Power Source: As used in this disclosure, an external power source is a source of the energy that is externally provided to enable the operation of the present disclosure. Examples of external power sources include, but are not limited to, electrical power sources and compressed air sources.

Flow: As used in this disclosure, a flow refers to the passage of a fluid past a fixed point. This definition considers bulk solid materials as capable of flow.

Fluid: As used in this disclosure, a fluid refers to a state of matter wherein the matter is capable of flow and takes the shape of a container it is placed within. The term fluid commonly refers to a liquid or a gas.

Fluidic Connection: As used in this disclosure, a fluidic connection refers to a tubular structure that transports a fluid from a first object to a second object. Methods to design and use a fluidic connections are well-known and documented in the mechanical, chemical, and plumbing arts.

Force of Gravity: As used in this disclosure, the force of gravity refers to a vector that indicates the direction of the pull of gravity on an object at or near the surface of the earth.

Form Factor: As used in this disclosure, the term form factor refers to the size and shape of an object.

Gas: As used in this disclosure, a gas refers to a state (phase) of matter that is fluid and that fills the volume of the structure that contains it. Stated differently, the volume of a gas always equals the volume of its container.

Geometrically Similar: As used in this disclosure, geometrically similar is a term that compares a first object to a second object wherein: 1) the sides of the first object have a one to one correspondence to the sides of the second object; 2) wherein the ratio of the length of each pair of corresponding sides are equal; 3) the angles formed by the first object have a one to one correspondence to the angles of the second object; and, 4) wherein the corresponding angles are equal. The term geometrically identical refers to a situation where the ratio of the length of each pair of corresponding sides equals 1.

Horizontal: As used in this disclosure, horizontal is a directional term that refers to a direction that is either: 1) parallel to the horizon; 2) perpendicular to the local force of gravity, or, 3) parallel to a supporting surface. In cases where the appropriate definition or definitions are not obvious, the second option should be used in interpreting the specification. Unless specifically noted in this disclosure, the horizontal direction is always perpendicular to the vertical direction.

Housing: As used in this disclosure, a housing is a rigid structure that encloses and protects one or more devices.

Humidity: As used in this disclosure, humidity refers water vapor that is dissolved in the atmosphere. The mass of water dissolved into the atmosphere is limited by the temperature of the atmosphere.

Interior: As used in this disclosure, the interior is used as a relational term that implies that an object is contained within the boundary of a structure or a space.

Lateral Disk Structure: As used in this disclosure, a lateral disk structure refers to the juxtaposition of a first lateral face of a first disk-shaped structure to a second lateral face of a second disk-shaped structure such that: a) the center axes of the first disk and the second disk are parallel; and, b) the congruent ends of the first disk are parallel to the congruent ends of the second disk. The span of the length of the center axes of the first disk and the second disk need not be equal. The form factor of the congruent ends of the first disk and the second disk need not be geometrically similar.

Lateral Prism Structure: As used in this disclosure, a lateral prism structure refers to the juxtaposition of a first lateral face of a first prism structure to a second lateral face of a second prism structure such that: a) the center axes of the first prism and the second prism are parallel; and, b) the congruent ends of the first prism are parallel to the congruent ends of the second prism. The span of the length of the center axes of the first prism and the second prism need not be equal. The form factor of the congruent ends of the first prism and the second prism need not be geometrically similar.

Liquid: As used in this disclosure, a liquid refers to a state (phase) of matter that is fluid and that maintains, for a given pressure, a fixed volume that is independent of the volume of the container.

National Electric Grid: As used in this disclosure, the national electric grid is a synchronized and highly interconnected electrical network that distributes energy in the form of electric power from a plurality of generating stations to consumers of electricity. The national electric grid is a commercially available source of AC electrical power. The national electric grid is regulated by an appropriate authority. The national electric grid comprises one or more utilities that sell electrical power for use by an electrical load. The national electric grid invoices for electrical power based on the total energy consumed by the electrical load. The national electric grid measures the energy consumption of an electrical load with an electrical meter. The national electric grid provides power through electrical connections known as a hot lead and a neutral lead.

Negative Space: As used in this disclosure, negative space is a method of defining an object through the use of open or empty space as the definition of the object itself, or, through the use of open or empty space to describe the boundaries of an object.

One to One: When used in this disclosure, a one to one relationship means that a first element selected from a first set is in some manner connected to only one element of a second set. A one to one correspondence means that the one to one relationship exists both from the first set to the second set and from the second set to the first set. A one to one fashion means that the one to one relationship exists in only one direction.

Pan: As used in this disclosure, a pan is a hollow and prism-shaped containment structure. The pan has a single open face. The open face of the pan is often, but not always, the superior face of the pan. The open face is a surface selected from the group consisting of: a) a congruent end of the prism structure that forms the pan; and, b) a lateral face of the prism structure that forms the pan. A semi-enclosed pan refers to a pan wherein the closed end of prism structure of the pan and/or a portion of the closed lateral faces of the pan are open.

Pedestal: As used in this disclosure, a pedestal is an intermediary load bearing structure that forms a load path between a supporting surface and an object, structure, or load.

Perimeter: As used in this disclosure, a perimeter is one or more curved or straight lines that bounds an enclosed area on a plane or surface. The perimeter of a circle is commonly referred to as a circumference.

Phase: As used in this disclosure, phase refers to the state of the form of matter. The common states of matter are solid, liquid, gas, and plasma.

Phase Change Terminology: As used in this disclosure, the following terms are used to describe a phase change. A phase change from a solid phase to a liquid phase is called melting. A phase change from a liquid phase to a solid phase is called freezing or solidification. A phase change from a solid phase to a gas phase is called sublimation. A phase change from a gas phase to a solid phase is called deposition. A phase change from a liquid phase to a gas phase is called evaporation. A phase change from a gas phase to a liquid phase is called condensation. A phase change from a gas phase to a plasma phase is called ionization. A phase change from a plasma phase to a gas phase is called recombination.

Port: As used in this disclosure, a port is an opening formed in a first object that allows a second object to pass through a boundary formed by the first object.

Prism: As used in this disclosure, a prism is a three-dimensional geometric structure wherein: 1) the form factor of two faces of the prism are congruent; and, 2) the two congruent faces are parallel to each other. The two congruent faces are also commonly referred to as the ends of the prism. The surfaces that connect the two congruent faces are called the lateral faces. In this disclosure, when further description is required a prism will be named for the geometric or descriptive name of the form factor of the two congruent faces. If the form factor of the two corresponding faces has no clearly established or well-known geometric or descriptive name, the term irregular prism will be used. The center axis of a prism is defined as a line that joins the center point of the first congruent face of the prism to the center point of the second corresponding congruent face of the prism. The center axis of a prism is otherwise analogous to the center axis of a cylinder. A prism wherein the ends are circles is commonly referred to as a cylinder.

Reservoir: As used in this disclosure, a reservoir refers to a container or containment system that is configured to store a liquid.

Solid: As used in this disclosure, a solid refers to a state (phase) of matter that: 1) has a fixed volume; and, 2) does not flow.

Tank: As used in this disclosure, a tank is an enclosed hollow structure used to store a fluid.

Tesla Valve: As used in this disclosure, a Tesla valve is a type of check valve that requires the use of no moving parts.

Tube: As used in this disclosure, the term tube is used to describe a hollow prism-shaped device with two congruent open ends. While tubes that are suitable for use in this disclosure are often used to transport or conveys fluids or gases, the purpose of the tubes in this disclosure are structural. In this disclosure, the terms inner dimension and outer dimension of a tube are used as they would be used by those skilled in the plumbing arts.

Valve: As used in this disclosure, a valve is a device that is used to control the flow of a fluid (gas or liquid) through a pipe, tube, or hose.

Vertical: As used in this disclosure, vertical refers to a direction that is either: 1) perpendicular to the horizontal direction; 2) parallel to the local force of gravity; or, 3) when referring to an individual object the direction from the designated top of the individual object to the designated bottom of the individual object. In cases where the appropriate definition or definitions are not obvious, the second option should be used in interpreting the specification. Unless specifically noted in this disclosure, the vertical direction is always perpendicular to the horizontal direction.

With respect to the above description, it is to be realized that the optimum dimensional relationship for the various components of the invention described above and in FIGS. 1 through 4 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A water-dispensing system with a dog bowl comprising
a water generation system, a condensate pump, a condensate filter, a power circuit, a water storage reservoir, a housing, a release valve, and a watering device;
wherein the housing contains the water generation system, the condensate pump, the condensate filter, the power circuit, the water storage reservoir, and the release valve.

2. The water-dispensing system with a dog bowl according to claim 1
wherein the water generation system, the condensate pump, the condensate filter, and the release valve are fluidically connected;
wherein the water generation system and the condensate pump electrically connect to the power circuit;
wherein the water generation system and the condensate pump receive electric energy from the power circuit;
wherein the housing mounts on the watering device.

3. The water-dispensing system with a dog bowl according to claim 2 wherein the housing attaches to the watering device such that the watering device provides a constant source of drinking water for the water bowl.

4. The water-dispensing system with a dog bowl according to claim 3
wherein the watering device further comprises a water pan and a housing pedestal;
wherein the housing pedestal attaches to the water pan to form a lateral prism structure;
wherein the water pan is a pan shaped structure;
wherein the water pan receives drinking water from the release valve;
wherein the housing attaches to the housing pedestal.

5. The water-dispensing system with a dog bowl according to claim 4
wherein the water generation system is a mechanical system that condenses water vapor from the atmosphere into a liquid phase condensate water;
wherein the condensate water is a source of water generated by the water generation system.

6. The water-dispensing system with a dog bowl according to claim 5
wherein the water generation system further comprises a dehumidifier and a condensate reservoir;
wherein the dehumidifier and the condensate reservoir are fluidically connected.

7. The water-dispensing system with a dog bowl according to claim 6
wherein the dehumidifier is a device that changes the phase of water vapor in the atmosphere into the liquid phase condensate water;
wherein the dehumidifier is an electrically operated device that draws electrical energy from the power circuit.

8. The water-dispensing system with a dog bowl according to claim 7
wherein the condensate reservoir is a containment structure;
wherein the condensate reservoir collects condensate water from the dehumidifier;
wherein the condensate reservoir stores the condensate water until the condensate pump pumps the condensate water through the condensate filter and into the water storage reservoir.

9. The water-dispensing system with a dog bowl according to claim 8
wherein the condensate reservoir further comprises a condensate discharge port;
wherein the condensate discharge port is a fluidic connection formed between the condensate reservoir and the condensate pump;
wherein the condensate pump draws the condensate water out of the condensate reservoir through the condensate discharge port for transport into the fluid input of the condensate filter.

10. The water-dispensing system with a dog bowl according to claim 9
wherein the condensate pump is a mechanical device;
wherein the condensate pump is an electrically powered device;
wherein the condensate pump transports the condensate water from the condensate reservoir and through the condensate filter into the water storage reservoir.

11. The water-dispensing system with a dog bowl according to claim 10
wherein the condensate filter is a filtering device;
wherein the condensate filter filters the condensate water as it passes through the condensate filter;
wherein the condensate filter converts the condensate water into the drinking water.

12. The water-dispensing system with a dog bowl according to claim 11
wherein the condensate filter further comprises a condensate check valve;
wherein the condensate check valve forms a direct fluidic connection between the discharge port of the condensate filter and the water storage reservoir;
wherein the condensate check valve transports the drinking water from the condensate filter into the water storage reservoir;
wherein the condensate check valve limits the direction of the flow of the drinking water to the direction from the condensate filter into the water storage reservoir.

13. The water-dispensing system with a dog bowl according to claim 12
wherein the power circuit is an electric circuit;
wherein the power circuit provides the electric energy necessary to operate both the water generation system and the condensate pump.

14. The water-dispensing system with a dog bowl according to claim 13
wherein the water storage reservoir is a container that stores the drinking water for the water bowl;
wherein the water storage reservoir forms a fluidic connection with the condensate filter;
wherein the water storage reservoir receives drinking water from the condensate filter.

15. The water-dispensing system with a dog bowl according to claim 14
wherein the release valve is a valve;
wherein the release valve releases the drinking water from the water storage reservoir into the water bowl;
wherein the release valve is controlled by a float mechanism;
wherein the float mechanism is a mechanical device;
wherein the float mechanism automatically opens and closes the release valve based on the amount of drinking water that is in the water bowl.
